(19) United States
(12) Patent Application Publication
(10) Pub. No.: US 2004/0088209 A1
(43) Pub. Date: May 6, 2004

(54) E-business method for selling or leasing out capacity upgrades for a process plant or machine

(76) Inventors: Tatu Pitkanen, Jarvenpaa (FI); Petteri Lannes, Jokela (FI)

Correspondence Address: LATHROP & CLARK LLP, 740 REGENT STREET SUITE 400, P.O. BOX 1507, MADISON, WI, 537011507

(21) Appl. No.: 10/283,894

(22) Filed: Oct. 30, 2002

(51) Int. Cl. G06F 17/60

(52) U.S. Cl. 705/10

(57) ABSTRACT

A business method which is to sell a papermaking machine or part of a papermaking machine which has value added features which maximize the capability in terms of machine speed and paper quality, at the price of a basic machine without the value added features, and to allow the purchaser of the papermaking machine to selectively enhance machine performance by the activation or enablement of the value added features in return for additional payments to the supplier of the papermaking machine.

### CROSS REFERENCES TO RELATED APPLICATIONS

Not applicable.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to methods of selling capital goods in general and papermaking machines in particular.

Papermaking machines are durable capital goods which have been manufactured for over 150 years. Like most capital goods, more and more of the value of the delivered product is no longer in the hardware, but in the control software. In fact because of the more mature nature of many of the physical aspects of the papermaking machine, the basic physical machine has a relatively low profit margin. Although relatively few suppliers exist who have the capability of manufacturing complete papermaking machines, worldwide markets dictate that papermaking machines be supplied at cost or with narrow profit margins. On the other hand, marginal profits can be very high in technology-intense control software, which is rapidly advancing and which can add considerable value to the papermaking machine while adding very little hardware.

The problem presented is how can an original equipment manufacturer which needs to concentrate on building complete systems compete effectively with aftermarket suppliers who supply value added products, such as software and controls, which marginally improve the capability or quality of the paper made on a particular machine.

A papermaking machine can produce hundreds of thousands of tons of paper per year, thus a small increase in value per pound of paper can be of large monetary value. An improvement in operating parameters may increase the value of the output with little or no additional costs in terms of power or process inputs. Alternatively, the quantity of paper produced may be increased, requiring additional process inputs and power but with the same basic capital cost. In either situation the process improvement can contribute greatly to profitability because additional revenues are gained without a proportional increased in costs. This situation—where the basic machine and the commodity it makes, paper, are both part of a mature commodity-type market where profit margins are very thin, focuses attention on achieving profitability through marginal improvements in productivity and quality. However, although economies of scale dictate relatively few manufacturers of complete papermaking machines, the number of suppliers for value added services which involve knowledge-based additions to existing papermaking machines is large. The problem is how can a manufacturer of papermaking machines retain the necessary focus on building complete systems while capturing a proportionate share of the higher profit, value added services.

### SUMMARY OF THE INVENTION

The business method of this invention is to sell a complete papermaking machine which has value added features which maximize the capability in terms of machine speed and paper quality, at a price of a basic machine without the value added features, and to allow the purchaser of the papermaking machine to selectively enhance machine performance in return for additional payments to the supplier of the papermaking machine. To improve the capabilities of the papermaking machine necessarily requires investments in research and development which must be recovered by charging more for the machine with such capabilities. However, if the purchaser of a papermaking machine does not need all the features, the purchaser is not willing to pay the additional cost inherent in these features. At the same time, the cost to the manufacture of adding the advanced features to a particular machine may, aside from the amortization of the research and development expenditures, be relatively small. Typically, a machine with advanced capabilities may consist of a machine which employs improved software, and perhaps controllers and sensors which are only marginally more expensive but have the capability of providing finer control over the papermaking machine. Thus the paper manufacturer sells a papermaking machine which incorporates the advanced technology features to a customer at a price which does not reflect the cost of these features. The machine thus sold has the advanced technology features, or is readily adapted for the installation of the advanced technology features, but they are not enabled. Subsequently, if the purchaser wishes to utilize the advanced features, additional payments are made to the manufacturer in return for unlocking software, or perhaps installing software and or minor hardware replaceable items. In this way the manufacturer takes on the risk that the advanced technology features will never be needed, and therefore no return will result from designing these features into the papermaking machine sold. The manufacturer can better bear these risks than the papermaking machine purchaser because the manufacturer can make the investment at the marginal cost, which is relatively low, while the papermaking machine purchaser must pay the market price for these features which is relatively high, which makes the investment risk of buying unneeded capacity high.

It is an object of the present invention to provide a method of marketing a papermaking machine which allows the machine manufacturer to more cost-effectively market machine improvements.

It is another object of the present invention to provide a method of investing in the prospect of upgrades to papermaking machines which are sold.

It is a further object of the present invention to provide a method of selling papermaking capacity with minimal or no transfer of physical assets.

It is yet another object of the present invention to provide a process for expanding the profit potential on papermaking technology by separating the marketing of hardware and software aspects of a papermaking machine.

Further objects, features and advantages of the invention will be apparent from the following detailed description when taken in conjunction with the accompanying drawings.

### BRIEF DESCRIPTION OF THE DRAWINGS

Not applicable.

### DESCRIPTION OF THE PREFERRED EMBODIMENTS

Although it can be difficult to produce and market computer software profitably, there are aspects of software marketing which are attractive. Perhaps the most attractive feature is that the marginal cost of producing a software product is very small and can approach zero. Thus with a software package which may have cost tens or hundreds of millions of dollars to develop, to produce one more copy may cost almost nothing. Thus software provides a product in which the marginal sale, i.e. each additional sale, can be very profitable. It is also a well-known marketing strategy to provide products which are differentiated by capacity and price. In this way it is possible to increase the market for a particular item while at the same time achieving the larger profits normally associated with products which have maximum capabilities. For example luxury cars typically have more profit margin associated with them than economy cars. The total market for cars, as well as the total profit on car sales is generally considered to be maximized by selling cars with a range of costs and features. It has also been widely commented upon, that the new economy is based on the sale of knowledge not the sale of physical assets.

The method of marketing papermaking machinery described herein builds on these marketing trends by defining a papermaking product which can be produced at low marginal cost, can be used to create product differentiation, and derives profitability through the sale of knowledge. The papermaking product is additional capacity of a papermaking machine which is included at no additional cost to the buyer of a papermaking machine, wherein the buyer of the papermaking machine is prevented from utilizing the additional capacity until the buyer makes or agrees to make a subsequent payment.

The capacity of a given papermaking machine can often be improved by the addition of software modifications and more sophisticated controls, together with additional sensors. Typically a customer for a papermaking machine purchases a machine of a capacity matched to the use to which the machine will be put. A purchaser of a papermaking machine evaluates the resources available in terms of fiber sources and the existing or hoped for marketing channels for the sale of paper. The purchaser of the papermaking machine then chooses to buy a papermaking machine matched to the anticipated grade and quantity of paper which will be produced and-sold. While it is possible that the purchaser of a papermaking machine will purchase a machine with additional capabilities at a higher cost in the expectation that these capabilities may find use in the future, buying unneeded capacity may be difficult to justify. The cost of the papermaking machine with added capacity to the purchaser without an immediate need for the added capacity will typically be the same as the cost to another maker of paper who will immediately use the added capacity. If one paper maker pays for capacity which is not used, and the other uses all the capacity paid for, the latter will have a lower capital cost. In a mature industry, where profit margins typically are very narrow, having higher capital costs is very undesirable.

In evaluating the cost of the upgrade in capacity, the analysis is greatly simplified where the buyer has identified a specific need for increased capacity. In this situation, the paper machine buyer compares additional cost to the expected additional profit from the use of the additional capacity. At the point in time when the additional capacity is needed, the uncertainty concerning use of the additional capacity is removed as well as the uncertainty that the added capacity will become technically obsolete, or will not address the particular market, whether for a higher grade of paper or for greater quality of paper.

On the other hand the paper machine manufacturer can purchase, or invest in additional capacity in the machines the paper machine manufacturer sells, at a low marginal cost, while the likelihood of the additional capacity being used is spread over multiple purchasers of papermaking machines allowing a statistical analysis of the investment risk. A paper machine manufacturer will typically invest in technology for improving the capacity of the papermaking machines it sells, because at least some customers will be willing to pay the additional cost of the technology improvements.

The marginal cost of adding additional capabilities to a papermaking machine can be extremely low or zero if these technology improvements consist of better programs, for example updates and automation systems, better control algorithms for the adjustment of certain processes, e.g. fuzzy, neural network or predictive adjustment control algorithms, or other software tools, useful for improving the papermaking processes, or storing and processing data relating to the papermaking processes, or predicting maintenance, or any other software. Of course the cost of a papermaking machine which can make use of improved software may be somewhat higher inasmuch as there is a need for more expensive controllers, controller boards, process and machine sensors; and more precise valves or other controllable parameters. In addition, the installation of more sophisticated software may require additional testing, calibration, or setup labor.

The capacity of a papermaking machine is defined herein as the speed and quality of the paper which can be made on the papermaking machine. Increased capacity means an increased papermaking speed, or the making of paper which is of greater value. The greater value of the paper may be achieved, for example, by forming a sheet which is more one-sided, has a greater caliper for a given weight, has better fiber orientation, produces a better paper finish, and other attributes such as those known to those skilled in the art of papermaking. Increasing capacity by increasing speed results in the manufacture of additional paper without substantial additional capital costs, thus increasing profitability. Increasing capacity by increasing paper quality can lead to additional revenue with a little or no additional cost. Therefore an increasing capacity which results from increased quality or value which amounts to only one or two percent may result in a substantial increase in profit derived from a particular papermaking machine and thus qualifies as a substantial increase in capacity. On the other hand increasing paper speed may require a speed increase of 10, 20, or 40 percent or more to achieve the same level of increased profitability and thus a substantial increase of capabilities with reference to speed will be in the foregoing ranges, for example a machine is sold with the capacity of 1800 m/min. but may have a capacity which can be increased to 2500 m/min. Of course an increase in papermaking capacity may be a combination of increasing papermaking speed and an increase in paper quality.

The means of increasing papermaking capacity may be arranged in modules of interrelated software or controller functionality so that increased papermaking capacity can be purchased in steps or even as a continuously variable function of the customer's need and willingness to pay. Where increased papermaking capacity is increased solely through unlocking or uploading data and programming code, the increased capacity can be purchased and billing can be carried out, through an estore (i.e. through transactions carried out by ecommerce techniques over the Internet) or portal designed for the customer. In this type of exchange, the customer selects the desired modules or desired capacity and receives the download of software keys or software upgrades to effect operation.

It is also possible that to achieve increased capacity it may be necessary to add proprietary items, such as sensors, controllers or minor items of hardware, which are proprietary to the papermaking machine manufacturer by way of patent, trade secret, copyright, or licensing reasons. These proprietary hardware items will have a relatively small intrinsic cost, i.e. cost to the papermaking machine manufacturer, a cost that is usually less than one percent of the purchase price of the papermaking machine. These systems may not be installed on the original machine as purchased because of their proprietary nature.

The purchaser of a papermaking machine may be limited to the capacity agreed upon at the time of purchase by contract, by licensing agreements, by software keys, by the lack of certain software, or by the lack of certain proprietary parts, or a combination of the foregoing. When the purchaser of a papermaking machine desires greater papermaking capacity, the purchaser is given access to the greater papermaking capacity by contract modifications, the providing a software or software keys, or proprietary parts or a combination of the foregoing in return for payment. The size of the payment may be negotiated or preferably will be the result of a calculator or table of papermaking capacity and price supplied to the papermaking machine purchaser at the time of purchase.

The selling of a papermaking machine, or increased capacity should be understood to include an outright sale for a given price or a lease agreement with terms and conditions which normally take account of financing costs, and the terms of lease result in substantially equivalent value received for the papermaking machine. If the papermaking machine is leased, the lease terms can be adjusted to increase the return to the supplier of the papermaking machine, in proportion to the increase in capacity which is made available, by the same means which are described with respect to an outright purchase. The lease terms may include leasing additional capacity for a limited period, after which the papermaking machine would be returned to its original capacity.

It should be understood that the relationship described as proportional is not limited to a relationship which is necessarily linear in proportionality.

It should be understood that the modifications performed on the papermaking machine to increase its capacity within the meaning of the claims can be distinguished from prior art rebuild techniques in that the value added is large compared to the cost of adding that value, i.e. downloading software or replacing limited proprietary components. For example, the manufacturer's cost of implementing the upgrade is zero to about one percent of the market value of the upgrade. This definition points to the fact that substantially all of the value added after the sale has been preinstalled in the machine as originally sold.

It should be understood that the prior art of course includes the practice of upgrading a papermaking machine by adding additional equipment. The invention is different from this past practice because the additional equipment (capacity) is added before the machine is sold, however the process of making the additional capacity available to the purchaser might require the addition of some hardware. This additional hardware differs in kind from the prior art type of rebuild or modification. The difference is a very insubstantial hardware addition whose main purpose is to unlock, or make available, capability already present, not to add capability which is not present. Past practices included the opposite approach of adding very little value to the machine when it is sold (for example attachment brackets), which facilitates the addition of equipment of substantial cost later.

It should be understood that the term “substantially less” as used to describe the sale price, means a price amounting to at least 5 percent, preferably 10 percent, and more preferably 25 percent less. Moreover, the term “substantially lower capacity” when referring to production speed refers to a papermaking machine which has a speed which is reduced by 10, 20, 40 percent or more, yet when referring paper of a reduced quality, this term means a quality which reduces the value of the paper by one percent or more.

It should be understood that the method of investing in additional capacity of a papermaking machine is applicable to any substantial part of a papermaking machine for example a reel-up, or a calendar. It should also be understood that the term papermaking machine includes a machine for making paperboard and the like.

It is understood that the invention is not limited to the particular construction and arrangement of parts herein illustrated and described, but embraces all such modified forms thereof as come within the scope of the following claims.

I claim:

1. A method of selling at least a substantial part of a papermaking machine comprising the steps of:
designing at least a substantial part of a papermaking machine of a first selected capacity which at the first selected capacity has a first sales price;
selling the part of a papermaking machine at a second price which is substantially less than the first sales price, and wherein the first selected capacity has been limited to a second substantially lower capacity, by a method selected from the methods consisting of, by contract, by software limitations, and by the absence of proprietary parts whose intrinsic cost is zero to about one percent of the second price;
selling increased capacity of the part of the papermaking machine at a third price which is proportional to the increased capacity;
supplying the increased capacity sold by a method selected from the methods consisting of: contract modification, software modification, and the addition of proprietary parts whose intrinsic cost is zero to about one percent of the second price.

2. The method of claim 1 wherein supplying the increased capacity sold is by the method of the addition of proprietary parts, and wherein the intrinsic value of said proprietary parts is less than one percent.

3. The method of claim 1 wherein the software limitations comprise software locks which can be removed by software modifications consisting of at least one software key.

4. The method of claim 1 wherein the software limitations comprise software locks which can be removed by the addition of a hardware key.

5. The method of claim 1 wherein the increased capacity of the papermaking machine is limited in time so that the price is proportional to the time limitation.

6. The method of claim 1 wherein the the step of supplying the increased capacity is accomplished by an electronic transfer of data.

7. The method of claim 6 wherein the step of supplying the increased capacity is accomplished through an e-commerce Internet based store.

8. The method of claim 1 wherein the increased capacity sold is an increase in paper quality.

9. The method of claim 1 wherein the increased capacity sold is an increase in paper production speed.

10. A method of investing in papermaking capacity comprising the steps of:
selling at least a substantial part of a papermaking machine at a first price which can achieve a first capacity by the addition of components having a marginal production cost of less than one percent of the first price, wherein the papermaking machine as sold has a capacity substantially less than the first capacity;
selling a modification to the papermaking machine which substantially increases its capacity for a second price substantially more than one percent of the first price which modification has a marginal cost of implementation which is less than one tenth of the second price.

11. The method of claim 10 wherein the substantial modification is a change to software running on the papermaking machine.

12. The method of claim 10 wherein the substantial modification is limited in time.

13. The method of claim 10 wherein the papermaking machine achieving the first capacity has a third price, and wherein the first price, and the second price are at least as much as the third price.

14. The method of claim 10 wherein the substantial modification is a change to contractual terms to allow operation of the papermaking machine to be operated at substantially greater capacity.

15. A method of selling at least a substantial part of a papermaking machines comprising the steps of:
selling at least a substantial part of a papermaking machine at a first price at a point in time, to a buyer wherein the seller invests in the machine sold by building in additional capacity, the cost of which built-in capacity is borne by the seller and the use of the additional capacity is controlled by the seller;
selling at least a portion of the additional capacity of the at least a substantial part of a papermaking machine to the buyer, at a second price at a time later than the point in time.

16. The method of claim 15 wherein the additional capacity is controlled by the seller by means selected from the group consisting of, by contract, by software limitations, by the absence of proprietary parts whose intrinsic cost is a small fraction of the second price; and wherein the selling of the at least a portion of the additional capacity is by means selected from the group consisting of, by contract, by software limitations, by the absence of proprietary parts whose intrinsic cost is a small fraction of the second price.

17. A method of selling at least a substantial part of a papermaking machine comprising the steps of:
designing at least a substantial part of a papermaking machine of a first selected capacity which at the first selected capacity has a first sales price;
selling the at least a substantial part of a papermaking machine at a second price which is substantially less than the first sales price, and wherein the first selected capacity has been limited by contract to a second substantially lower capacity, by contract;
selling increased capacity of the papermaking machine at a price which is proportional to the increased capacity; and
supplying the increased capacity sold by contract modification.

18. A method of selling papermaking machines comprising the steps of:
designing a papermaking machine of a first selected capacity which at the first selected capacity has a first sales price;
selling the papermaking machine at a second price which is substantially less than the first sales price, wherein the first selected capacity has been limited to a second substantially lower capacity, by software limitations;
selling increased capacity of the papermaking machine at a price which is proportional to the increased capacity;
supplying the increased capacity sold by software modification.
